(19) United States
(12) Patent Application Publication
(10) Pub. No.: US 2011/0220828 A1
(43) Pub. Date: Sep. 15, 2011

(54) SLUICE GATE VALVE

(75) Inventor: Paul G. Kennedy, Horseheads, NY (US)

(73) Assignee: PENN TROY MACHINE COMPANY, INC., Troy, PA (US)

(21) Appl. No.: 12/722,982

(22) Filed: Mar. 12, 2010

(51) Int. Cl. F16K 3/00

(52) U.S. Cl. 251/328

(57) ABSTRACT

The sluice gate valve includes at least one binding reduction mechanism to reduce binding during actuation of the sluice gate. In one embodiment the mechanism includes a the guide elements and the tracks, the guide elements and the tracks being arranged such that a predetermined amount of rotational motion of the gate around the stem is permitted during actuation of the valve to reduce valve binding. In another embodiment the mechanism includes a stuffing box assembly including a stuffing box, a bushing, and a collar, where a convex curved surface of the collar slides on a concave curved surface of the bushing such that a predetermined amount of pivoting of the stem up to a predetermined cone angle is allowed. In a preferred embodiment the sluice gate valve includes both mechanisms.

### BACKGROUND OF THE INVENTION

1. Field of the Invention

The invention pertains to the field of valves. More particularly, the invention pertains to a sluice gate valve with a pivotable actuation assembly.

2. Description of Related Art

Sluice gate valves, also known as slide gate valves, are known in the art. The sluice gate is typically a wooden or metal plate, which may be circular or rectangular and which slides in grooves of channels in the side of the valve body to actuate the valve. Sluice gates are commonly used in rivers or canals to control water levels and flow rates, in mining operations to recover minerals, and in wastewater treatment plants.

A gate valve includes an open frame and a slide. Modern sluice gates are commonly made of cast iron or stainless steel. The valve seat may be non-metallic and may have a self-adjusting design. Seats or seals of ultra high molecular weight (UHMW) polyethylene are often used to allow ease of movement and eliminate friction during actuation of the valve. Sluice gate valves may be of the rising stem or the non-rising stem type. In a rising stem sluice, the threaded stem, also known as a spindle, moves upward and downward with the sluice gate during operation. In a non-rising stem sluice, the threaded stem maintains its vertical position as the gate moves upward and downward with respect to the stem and the valve body.

A prior art sluice gate valve is shown schematically in FIG. 1 and FIG. 2. The sluice gate valve 10 includes a cap 12 and a body 14. In a closed state, the sluice gate 16 sits in the valve seat 18 to block the orifice 20 of the sluice gate valve 10. Turning of the stem 22, which is threaded, actuates the sluice gate to open and close the valve. The stem 22 passes through a thrust nut 24, which is complementarily threaded for a non-rising stem sluice gate valve. Alternatively, in a rising stem sluice gate valve, the cap 12 or neck 26 is threaded. The sluice gate 16 is guided upward and downward with respect to the valve body 14 by a left wedge 28 traveling in a left track of a left guide 30 and a right wedge 32 traveling in a right track of a right guide 34. A mounting section 36 is mounted to the end of a pipe or other conduit to align the orifice 20 with the conduit to be controlled by the sluice gate valve 10.

Since the sluice gate actuates in a direction substantially parallel to the valve seat, binding of the sluice gate is a common problem in sluice gate valves. Modifications to reduce or eliminate the occurrences of binding are known in the art.

In U.S. Pat. No. 4,288,059, entitled SLUICE GATE, Gurbin discloses a sluice gate, where the apparatus controlling fluid flow through the gate opening includes a frame and a guide system adapted to retain a gate disc in a slidable relation with the opening. A drawing system laterally displacing the disc relative to the opening is pivotably connected to a lever having long and short ends. A fulcrum between the ends is pivotably connected to the disc. The short end is disposed to bear against a fixed portion of the guide system when the disc is closed, and the long end is connected to the drawing system to obtain a mechanical advantage in drawing pressure when displacing the disc to a partially open position. The lever may be a single lever or a pair of levers to apply a uniform drawing pressure on the disc via a hydraulic cylinder.

In U.S. Pat. No. 5,415,375, entitled CLOSING SYSTEM FOR CONTROLLING A FLOW WITH PRECISION, Gaboriault discloses a closing system with a closure member and a carriage for translational displacement of the closing member along rails. A jack is mounted on the carriage for non-resilient axial displacements of the closure member to and from a flow opening. The closure member closes the flow opening by first axially aligning the closure member with respect to the flow opening by displacing the carriage. The jack includes pivoting U-shaped arms and axially displaces the closure member to urge the closure member against the flow opening to close it without translational displacement. The closure member is retracted away a minimal distance from the opening for clearance, and then the carriage is actuated to reduce or enlarge the flow opening with precision and without friction to a seal disposed about the opening.

In U.S. Pat. No. 6,287,051, entitled FIXABLE SEAL SLUICE GATE, Wood et al. disclose a sluice gate with a valve vise having pivot gearing that forces the sluice gate valve uniformly and tightly into sealing contact with a domed seal ring. A plate locator on the valve vise sets the sluice gate plate in a predetermined sealing position for a selected structure of the fixable-seal sluice gate. A dome flange on one or both sides of a base of the domed seal ring is removably bracketed to the sluice gate wall or the sluice gate plate for attachment and detachment of the domed seal ring. In one embodiment, a plate locator is pivotal to the aperture axis with a locator beam that is pivotal on a pivot axis that is orthogonal to the axis of the sluice gate aperture. The sluice gate plate is pivotal limitedly on a ball-and-socket joint on the locator beam for allowing coplanar positioning of the sluice gate plate and the domed seal ring.

### SUMMARY OF THE INVENTION

The sluice gate valve includes at least one binding reduction mechanism to reduce binding during actuation of the sluice gate. In one embodiment the mechanism includes a the guide elements and the tracks, the guide elements and the tracks being arranged such that a predetermined amount of rotational motion of the gate around the stem is permitted during actuation of the valve to reduce valve binding. In another embodiment the mechanism includes a stuffing box assembly including a stuffing box, a bushing, and a collar, where a convex curved surface of the collar slides on a concave curved surface of the bushing such that a predetermined amount of pivoting of the stem up to a predetermined cone angle is allowed. In a preferred embodiment the sluice gate valve includes both mechanisms.

### BRIEF DESCRIPTION OF THE DRAWINGS

FIG. 1 shows a front view of a prior art sluice gate valve.

FIG. 2 shows a side view of the sluice gate valve of FIG. 1.

FIG. 3 shows an elevated side view of a sluice gate valve in a first embodiment of the present invention.

FIG. 4 shows an exploded view of the valve of FIG. 3.

FIG. 5 shows an elevated side view of a sluice gate valve in a second embodiment of the present invention.

FIG. 6 shows an elevated side view of a sluice gate valve in a third embodiment of the present invention.

FIG. 7 shows a rear view of the valve of FIG. 6.

FIG. 8 shows an elevated bottom view of the valve of FIG. 6.

FIG. 9 shows an elevated top view of the valve of FIG. 6.

FIG. 10 shows an exploded view of the valve of FIG. 6.

FIG. 11 shows an exploded detailed view of a stuffing box assembly of the present invention.

FIG. 12 shows a schematic view of a track with two guide elements in an embodiment of the present invention.

FIG. 13 shows a schematic view of two guide elements in separate tracks in an embodiment of the present invention

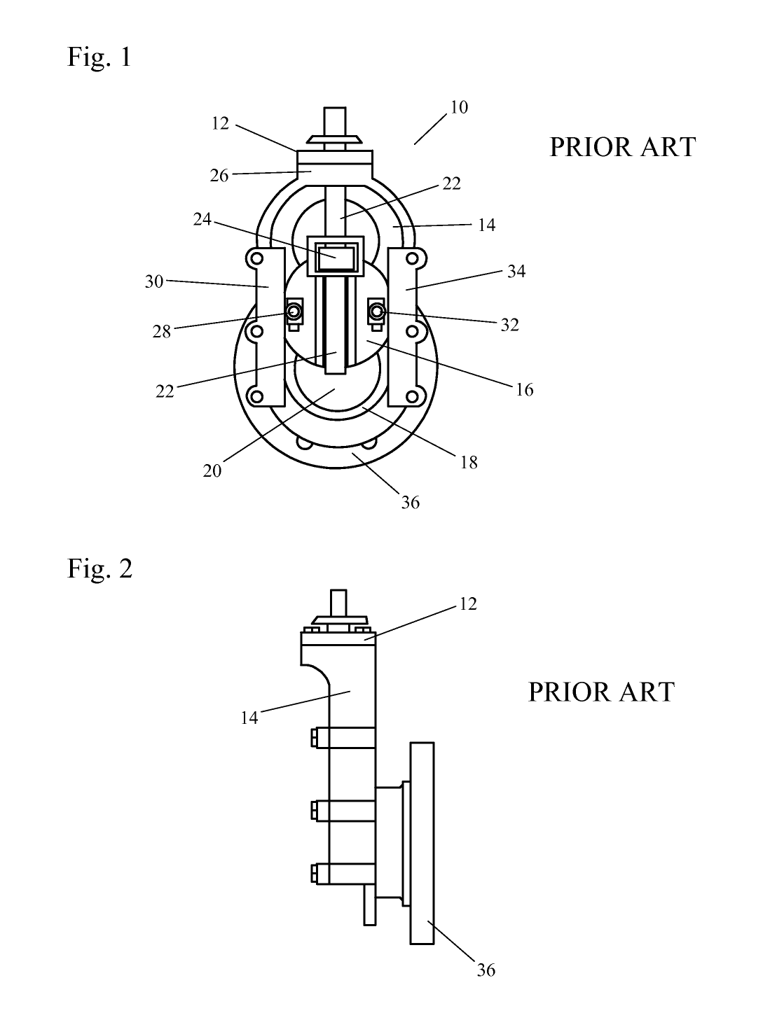

### DETAILED DESCRIPTION OF THE INVENTION

The following terms as used herein are defined relative to the orientation of a sluice gate valve. With reference to the prior art valve shown in FIG. 1, the front of the valve is defined as the shown part of the valve in FIG. 1, and the rear is the part opposite the front. The top or upper part of the valve is the part of the valve toward the top of FIG. 1, and the bottom or lower part of the valve is the part of the valve toward the bottom of FIG. 1. The sides of the valve are facing to the left and the right in FIG. 1. In descriptions of the movement of the sluice gate during actuation, frontward is in a direction toward the front of the valve, rearward is in a direction toward the rear, upward is in a direction toward the top, downward is in a direction toward the bottom, and sideward is in a direction toward the left or right side.

The term “non-actuating motion of the sluice gate” as used herein refers to any motion of the sluice gate that does not result in a net movement of the sluice gate along the tracks including, but not limited to, rotation of the sluice gate around the stem, top-to-bottom tilting of the sluice gate away from the angling of the tracks, in-plane rotation of the sluice gate due to a pivoting of the stem around a pivot point in the stuffing box, and any combination of theses movements.

Prior art sluice valve gates of the type upon which the present invention improves typically hold around 30 feet of head pressure or about 15 psi of pressure. Sluice gate valves of the present invention have been observed to hold greater than 85 psi of pressure and in some cases up to 200 psi of pressure, which is a significant improvement upon the prior art.

Structural components of a sluice gate valve of the present invention are preferably made of iron with a powder plastic coating or stainless steel with no coating.

The valve body of a sluice gate valve of the present invention is preferably cast as a single piece with the grooves for the guide elements being machined after the valve body is cast.

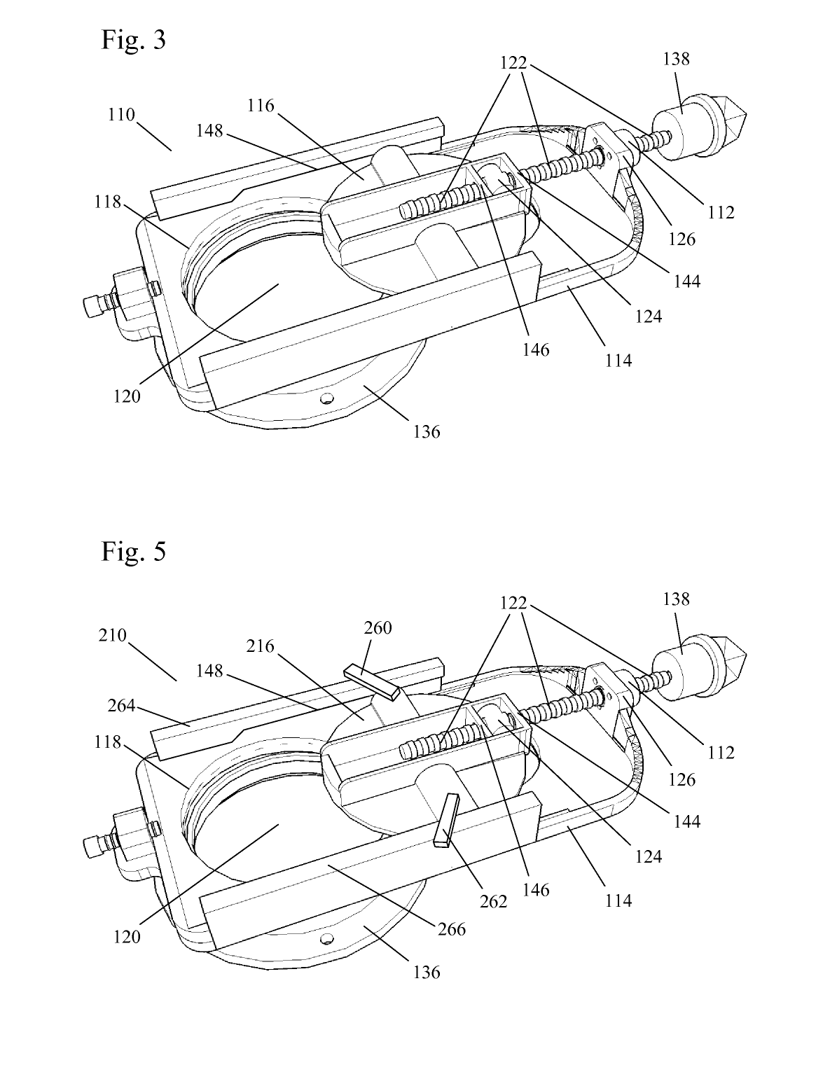

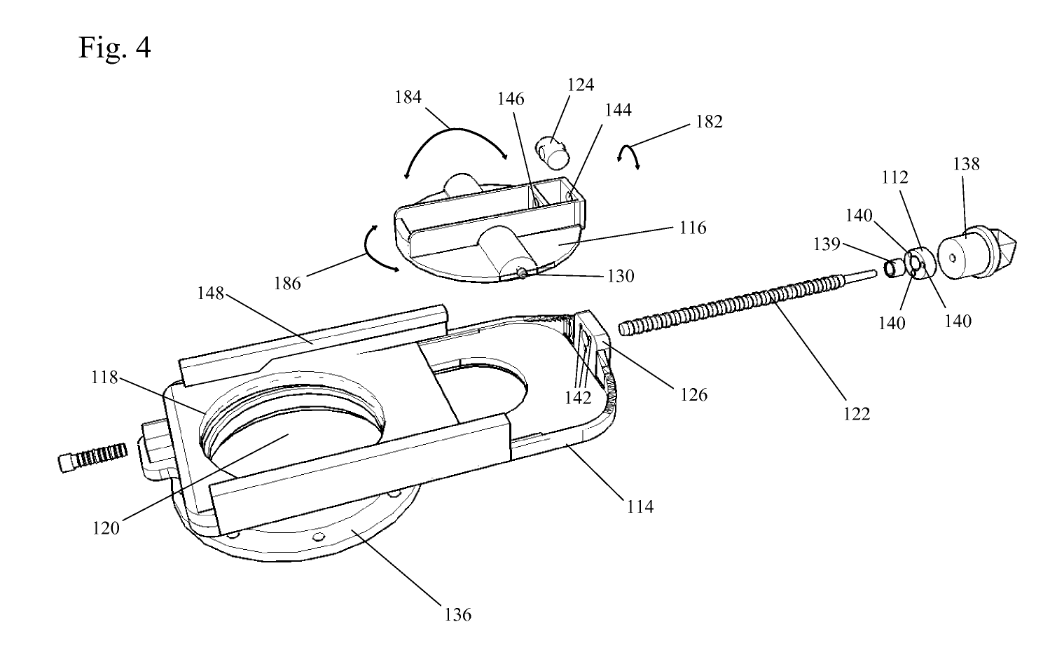

FIG. 3 and FIG. 4 show a sluice gate valve in a first embodiment of the present invention. The sluice gate valve 110 includes a stuffing box 112, a valve body 114, and a sluice gate 116. In a closed state, the sluice gate 116 sits in the valve seat 118 to block the orifice 120 of the sluice gate valve 110. A mounting section 136 is mounted to the end of a pipe or other conduit to maintain the orifice 120 in a predetermined alignment with the conduit to be controlled by the sluice gate valve 110. The valve 110 is preferably mounted using a plurality of bolts or screws. Turning of the stem 122, which is threaded, actuates the sluice gate to open and close the valve. The sluice gate valve preferably includes a knob 138, mounted on the end of the stem 122, which is turned to actuate the valve. In the assembled state, the stem 122 passes through the stuffing box 112 and the neck 126 of the valve body. The stuffing box 112 is preferably mounted to the neck 126 by screws or bolts (not shown) through holes 140 in the stuffing box and holes 142 in the neck. Although three screw holes for three screws or bolts are shown and preferred, any number of screws or bolts may be used to mount the stuffing box to the neck within the spirit of the present invention. The stem 122 is coupled to the sluice gate 116 through a pair of holes 144, 146.

A thrust nut 124 with a through-hole is mounted between the two holes 144, 146 on the gate 116 and maintains the stem 122 on the gate 116. In a rising stem sluice gate valve embodiment, the thrust nut 124 and gate 116 maintain their vertical positions with respect to the stem 122, and the stem 122 is threaded with respect to the stuffing box 112 or neck 126 such that the stem 122 rides up or down the with respect to the neck 126 as the stem 122 is turned, thereby vertically adjusting the gate 116 with respect to the valve body 114. In a non-rising stem sluice gate valve embodiment, the thrust nut 124 is threaded complementarily to the stem 122 so that the thrust nut 124 and gate 116 ride up and down the stem 122 when the stem is turned.

The sluice gate 116 is guided upward and downward by guide elements 130, which are located on opposite sides of the sluice gate and travel upward and downward in tracks 148 running along the valve body 114. Since the stem 122 and thrust nut 124 permit rotational 182 motion of the gate 116 around the axis of the stem 122, the tracks 148 are designed to limit this rotational motion to reduce binding of the gate 116 during actuation of the valve. The tracks 148 in this embodiment only consist of rear-facing surfaces to limit the frontward movement of each guide element 130. In a preferred embodiment, the guide elements 130 are pins. The tracks 148 preferably angle rearward toward the valve seat at an angle of about 5 degrees prior to the gate seating on the valve seat.

FIG. 5 shows a sluice gate valve in a second embodiment of the present invention. The sluice gate valve 210 operates in a similar manner to the sluice gate valve 110 of FIG. 3 and FIG. 4, except that ears 260, 262 are attached to a front surface of the sluice gate 216. These ears 260, 262 slide along the front surfaces 264, 266 of rails on the valve body flanking the sluice gate. The front surfaces 264, 266 preferably angle rearward toward the valve seat 118 at the same angle as the tracks 148. The ears 260, 262 limit the rearward motion of the sluice gate 216 during actuation.

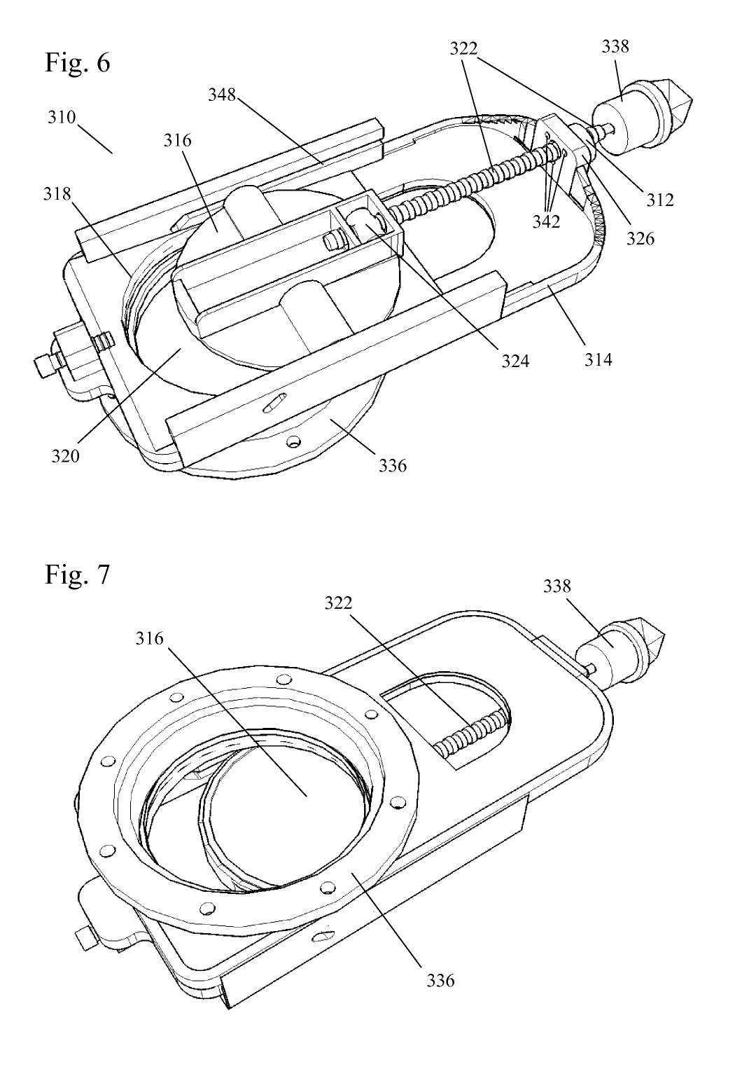

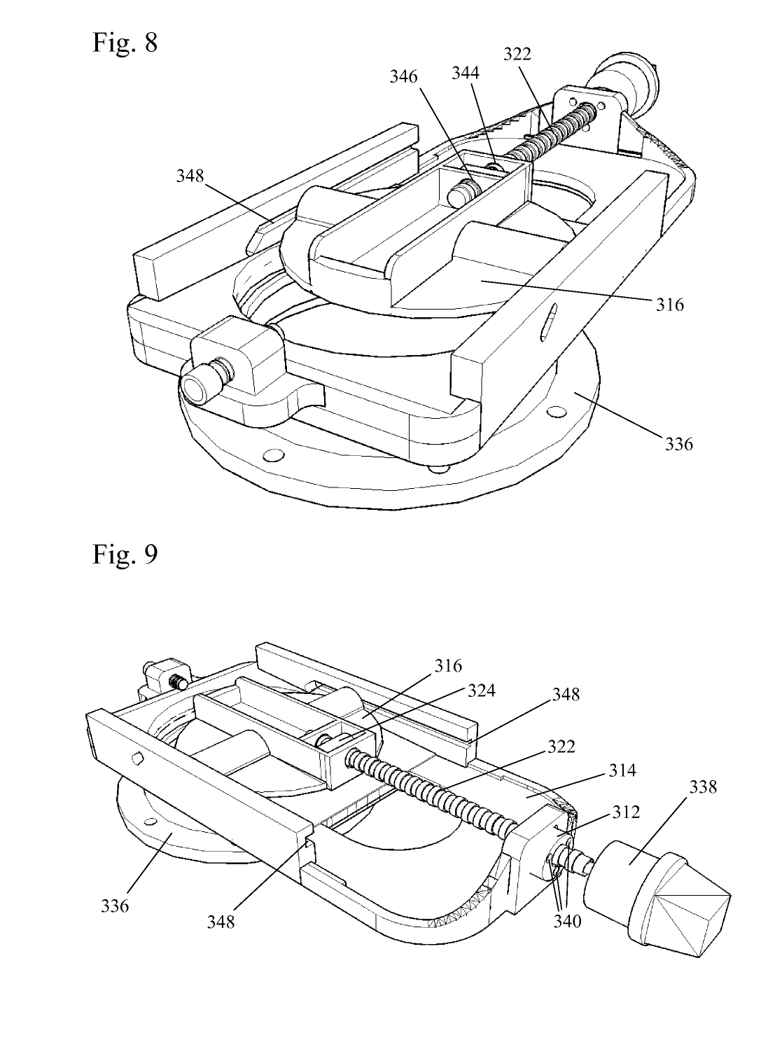

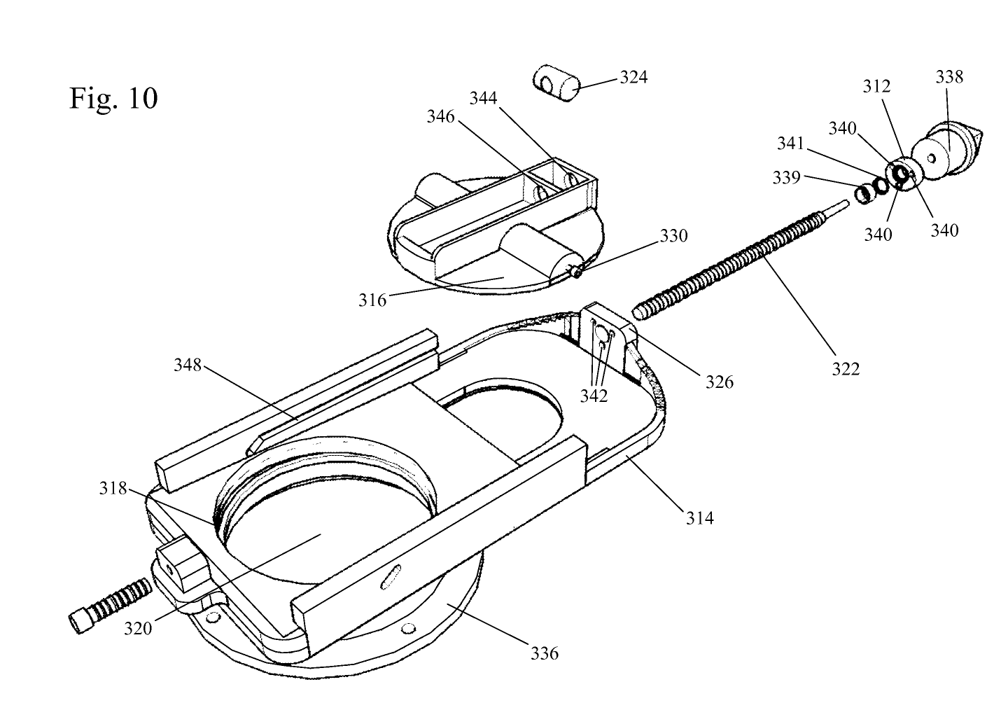

FIG. 6 through FIG. 10 show a sluice gate valve in a third embodiment of the present invention. The sluice gate valve 310 includes a stuffing box 312, a valve body 314, and a sluice gate 316. In a closed state, the sluice gate 316 sits in the valve seat 318 to block the orifice 320 of the sluice gate valve 310. A mounting section 336 is mounted to the end of a pipe or other conduit to maintain the orifice 320 in a predetermined alignment with the conduit to be controlled by the sluice gate valve 310. The valve 310 is preferably mounted using a plurality of bolts or screws. Turning of the stem 322, which is threaded, actuates the sluice gate to open and close the valve. The sluice gate valve preferably includes a knob 338, mounted on the end of the stem 322, which is turned to actuate the valve. In the assembled state, the stem 322 passes through the stuffing box 312 and the neck 326 of the valve body. The stuffing box 312 is preferably mounted to the neck 326 by screws or bolts (not shown) through holes 340 in the stuffing box and holes 342 in the neck. A collar 339 and a bushing 341 are preferably mounted in a recess of the stuffing box 312 in the assembled sluice gate valve 310. Although three screw holes for screws or bolts are shown and preferred, any number of screws or bolts may be used to mount the stuffing box to the neck within the spirit of the present invention. The stem 322 is coupled to the front-facing part of the sluice gate 316 through a pair of holes 344, 346.

A thrust nut 324 with a through-hole is mounted between the two holes 344, 346 on the gate 316 and maintains the stem 322 on the gate 316. In a rising stem sluice gate valve embodiment, the thrust nut 324 and gate 316 maintain their vertical positions with respect to the stem 322, and the stem 322 is threaded with respect to the stuffing box 312 or neck 326 such that the stem 322 rides up or down the with respect to the neck 326 as the stem 322 is turned, thereby vertically adjusting the gate 316 with respect to the valve body 314. In a non-rising stem sluice gate valve embodiment, the thrust nut 324 is threaded complementarily to the stem 322 so that the thrust nut 324 and gate 316 ride up and down the stem 322 when the stem is turned.

The sluice gate 316 is guided upward and downward by guide elements 330, which are located on opposite sides of the sluice gate and travel upward and downward in tracks 348 running along the valve body 314. Since the stem 322 and thrust nut 324 permit rotational motion of the gate 316 around the axis of the stem 322, the tracks 348 are designed to limit this rotational motion to reduce binding of the gate 316 during actuation of the valve. The tracks 348 in this embodiment only consist of rear-facing surfaces to limit the frontward movement of each guide element 330. In a preferred embodiment, the guide elements 330 are pins. The tracks 348 preferably angle rearward toward the valve seat at an angle of about 5 degrees prior to the gate seating on the valve seat.

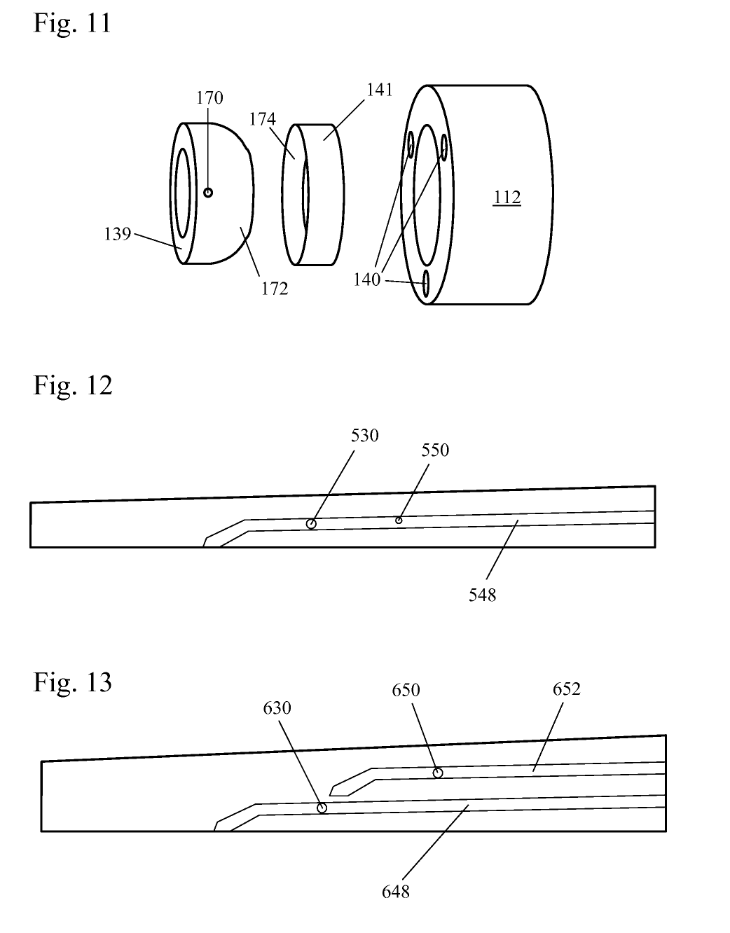

FIG. 11 shows an exploded view of a preferred stuffing box assembly of the present invention. Although the assembly is described with respect to the first embodiment, the assembly may be used with any of the described embodiments. The stuffing box 112 has three through-holes 140 for mounting the stuffing box to the neck 126 of the valve body using screws or bolts. A collar 139 and a bushing 141 are preferably mounted in a recess of the stuffing box 112 in the assembled sluice gate valve 110. The collar 139 preferably has at least one roll pin 170 to hold the collar onto the shaft of the stem (not shown). The collar 139 preferably has a curved surface 172 facing the bushing 141, and the bushing 141 preferably has a complementary curved inside cut surface 174 facing the collar 139 such that in the assembled sluice gate valve 110 the collar 139 inserts partially into the bushing 141. The curved surfaces 172, 174 are preferably spherical in shape. The stuffing box assembly is designed to allow the stem to pivot up to a predetermined cone angle, thereby allowing a greater range of motion for the sluice gate 116 to reduce the frequency of incidences of binding during valve actuation. This pivoting of the stem permits predetermined amounts of top-to-bottom tilting or tipping 184 (see FIG. 4) of the sluice gate away from the angling of the tracks, in-plane rotation 186 (see FIG. 4) of the sluice gate clockwise or counter-clockwise, and combinations of these two types of motion during actuation, in addition to the rotational 182 (see FIG. 4) motion available to the gate. The collar 139 pivots with respect to the bushing 141 along their complementary curved surfaces during this movement.

FIG. 12 shows a schematic view of a pair of guide elements in a track in an embodiment of the present invention. In this embodiment, the first guide element 530 is the primary guide element traveling in the track 548. The second guide element 550 limits the degree of tipping of the gate during actuation of the valve. The guide elements 530, 550 are preferably pins. The first guide element 530 is preferably similar to the previously-described guide elements 130, 330 in that it is located at or near the centerline of the gate and in its size. The track 548 is preferably similar in size and shape to the previously described track 348 with two side walls. The second guide element 550 is preferably smaller than and trailing the first guide element 530 by a predetermined distance and rides in the same track 548 as the first guide element 530. The first guide elements 530, the second guide elements 550, and the tracks 548 are preferably designed such that in the assembled sluice gate valve, the amount of tipping of the gate is controlled during actuation of the valve to minimize binding, especially during seating and unseating. The tracks and guide elements preferably have mirror symmetry on the two sides of the gate, although they may be asymmetrical within the spirit of the present invention.

FIG. 13 shows a schematic view of a pair of guide elements traveling in separate tracks in an embodiment of the present invention. In this embodiment, the first guide element 630 travels in the first track 648, and the second guide element 650 travels in the second track 652. The guide elements 630, 650 are preferably pins. The first guide element 630 and second guide element 650 are preferably similar to the previously-described guide elements 130, 330 in their relative sizes with respect to the tracks. The first guide element 630 is preferably located in front of the centerline of the gate. The second guide element 650 is located a predetermined distance behind the first guide element 630 and offset by a predetermined height so that its path does not cross the path of the first guide element 630. The second guide element 650 is preferably located behind the centerline of the gate, more preferably a distance equal to the distance the first guide element 630 is in front of the center line. The first guide elements 630, the second guide elements 650, and the tracks 648, 652 are preferably designed such that in the assembled sluice gate valve, the amount of tipping of the gate is controlled during actuation of the valve to minimize binding, especially during seating and unseating. The tracks and guide elements preferably have mirror symmetry on the two sides of the gate, although they may be asymmetrical within the spirit of the present invention.

In a preferred embodiment, a sluice gate valve of the present invention includes both the pivoting feature of FIG. 11 and the pivoting feature of FIG. 12 or FIG. 13. The combination of these two pivoting features allows predetermined amounts of rotational, frontward, rearward, and sideward motion of the sluice gate during actuation of the sluice gate valve, thereby reducing the likelihood of binding of the valve during actuation.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A sluice gate valve comprising:
a sluice gate having at least one gate hole and comprising at least one pair of guide elements located on opposite sides of the sluice gate;
a valve body comprising:
a valve seat;
at least one pair of tracks flanking the valve seat and angling toward the valve seat, wherein the guide elements move along the tracks to guide the sluice gate during actuation of the sluice gate valve; and
a valve neck having a neck hole;
a threaded valve stem passing through the neck hole and the gate hole; and
at least one binding reduction mechanism providing a predetermined amount of non-actuating motion of the sluice gate during actuation of the valve.

2. The sluice gate valve of claim 1, wherein:
the at least one gate hole includes a first gate hole and a second gate hole;
the sluice gate valve further comprises a thrust nut having a thrust hole;
the threaded valve stem passes through the first gate hole, the thrust hole, and the second gate hole;
the binding reduction mechanism comprises the at least one pair of guide elements and the at least one pair of tracks; and
the guide elements and the tracks are arranged such that a predetermined amount of rotational motion of the gate around the stem is permitted during actuation of the valve to reduce valve binding.

3. The sluice gate valve of claim 2, wherein the at least one pair of guide elements comprises a leading pair of guide elements and a trailing pair of guide element, wherein the guide elements and the tracks are arranged such that a predetermined amount of tipping motion of the gate is permitted during actuation of the valve to reduce valve binding.

4. The sluice gate valve of claim 3, wherein the at least one pair of tracks comprises a leading pair of tracks and a trailing pair of tracks separate from the leading pair of tracks, the leading pair of guide elements traveling in the leading pair of tracks and the trailing pair of guide elements traveling in the trailing pair of tracks.

5. The sluice gate valve of claim 1, wherein the binding reduction mechanism comprises:
a stuffing box having a recess and a stuffing box hole;
a bushing having a bushing hole and a concave curved bushing surface; and
a collar having a collar hole and a convex curved collar surface;
wherein the valve stem passes through the stuffing box hole, the bushing hole, and the collar hole;
wherein the recess faces the top surface of the neck, the collar and the bushing are mounted in the recess with the collar located between the bushing and the neck when the sluice gate valve is assembled; and
wherein the convex curved collar surface is slidable on the concave curved bushing surface such that the stem is pivotable up to a predetermined cone angle.

6. The sluice gate valve of claim 5, wherein the collar comprises at least one roll pin to hold the collar onto the stem.

7. A sluice gate valve comprising:
a sluice gate having a first gate hole and a second gate hole and comprising at least one pair of guide elements located on opposite sides of the sluice gate;
a thrust nut having a thrust hole and mounted between the first gate hole and the second gate hole;
a valve body comprising:
a valve seat;
at least one pair of tracks flanking the valve seat and angling toward the valve seat, wherein the guide elements travel in the tracks to guide the sluice gate during actuation of the sluice gate valve; and
a valve neck having a neck hole; and
a threaded valve stem passing through the neck hole, the first gate hole, the thrust hole, and the second gate hole;
wherein the guide elements and the tracks are arranged such that a predetermined amount of rotational motion of the gate around the stem is permitted during actuation of the valve to reduce valve binding.

8. The sluice gate valve of claim 7, wherein the at least one pair of guide elements comprises a leading pair of guide elements and a trailing pair of guide element, wherein the guide elements and the tracks are arranged such that a predetermined amount of tipping motion of the gate is permitted during actuation of the valve to reduce valve binding.

9. The sluice gate valve of claim 8, wherein the at least one pair of tracks comprises a leading pair of tracks and a trailing pair of tracks separate from the leading pair of tracks, the leading pair of guide elements traveling in the leading pair of tracks and the trailing pair of guide elements traveling in the trailing pair of tracks.

10. The sluice gate valve of claim 7 further comprising a stuffing box assembly mounted to a top surface of the valve neck and comprising:
a stuffing box having a recess and a stuffing box hole;
a bushing having a bushing hole and a concave curved bushing surface; and
a collar having a collar hole and a convex curved collar surface;
wherein the valve stem passes through the stuffing box hole, the bushing hole, and the collar hole;
wherein the recess faces the top surface of the neck, the collar and the bushing are mounted in the recess with the collar located between the bushing and the neck when the sluice gate valve is assembled;
wherein the convex curved collar surface is slidable on the concave curved bushing surface such that the stem is pivotable up to a predetermined cone angle.

11. The sluice gate valve of claim 10, wherein the collar comprises at least one roll pin to hold the collar onto the stem.

12. The sluice gate valve of claim 7, wherein each track is formed by a rear-facing surface limiting a frontward movement of its respective guide element.

13. The sluice gate valve of claim 12, wherein each track is further formed by a front-facing surface limiting a rearward movement of its respective guide elements.

14. The sluice gate valve of claim 12 further comprising a pair of ears mounted to a front-facing surface of the sluice gate, a front surface of the valve body limiting a rearward movement of each ear.

15. A sluice gate valve comprising:
a sluice gate having a first gate hole and a second gate hole and comprising at least one pair of guide elements located on opposite sides of the sluice gate;
a thrust nut having a thrust hole and mounted between the first gate hole and the second gate hole;
a valve body comprising:
a valve seat;
at least one pair of tracks flanking the valve seat and angling toward the valve seat, wherein the guide elements travel in the tracks to guide the sluice gate during actuation of the sluice gate valve; and
a valve neck having a neck hole;
a threaded valve stem passing through the neck hole, the first gate hole, the thrust hole, and the second gate hole;
a stuffing box having a recess and a stuffing box hole;
a bushing having a bushing hole and a concave curved bushing surface; and
a collar having a collar hole and a convex curved collar surface;
wherein the valve stem passes through the stuffing box hole, the bushing hole, and the collar hole;
wherein the recess faces the top surface of the neck, the collar and the bushing are mounted in the recess with the collar located between the bushing and the neck when the sluice gate valve is assembled; and
wherein the convex curved collar surface is slidable on the concave curved bushing surface such that the stem is pivotable up to a predetermined cone angle.

16. The sluice gate valve of claim 15, wherein the collar comprises at least one roll pin to hold the collar onto the stem.

17. The sluice gate valve of claim 15, wherein each track is formed by a rear-facing surface limiting a frontward movement of its respective guide element.

18. The sluice gate valve of claim 17, wherein each track is further formed by a front-facing surface limiting a rearward movement of its respective guide element.

19. The sluice gate valve of claim 17 further comprising a pair of ears mounted to a front-facing surface of the sluice gate, a front surface of the valve body limiting a rearward movement of each ear.
